(19) United States
(12) Patent Application Publication
(10) Pub. No.: US 2026/0109325 A1
(43) Pub. Date: Apr. 23, 2026

(54) DOOR LOCK CONTROL METHOD, DOOR LOCK, AND COMPUTER DEVICE

(71) Applicant: Shenzhen Oceanwing Smart Innovations Technology Co., Ltd, SHENZHEN (CN)

(72) Inventor: Xiaojian FU, SHENZHEN (CN)

(73) Assignee: Shenzhen Oceanwing Smart Innovations Technology Co., Ltd, SHENZHEN (CN)

(21) Appl. No.: 19/362,416

(22) Filed: Oct. 19, 2025

(30) Foreign Application Priority Data
Oct. 21, 2024 (CN) 202411472395.5

(51) Int. Cl. B60R 25/31; B60R 25/24; B60R 25/30; B60R 25/40; G06V 40/14

(52) U.S. Cl. CPC B60R 25/31; B60R 25/245; B60R 25/305; B60R 25/403; G06V 40/14

(57) ABSTRACT

The present application relates to a door lock control method, a door lock, and a computer device. The method includes: acquiring an environmental perception result and performing power supply control to a distance sensor according to the environmental perception result; in a case where the distance sensor is powered on, acquiring a distance between a palm and a door lock collected by the distance sensor; and performing power supply control to a palm vein recognition module according to the distance between the palm and the door lock; the palm vein recognition module is configured to acquire a target image and perform palm vein recognition detection on the target image to control a status of the door lock. In the above-mentioned method, based on the door lock including multiple sensors, various sensors are awakened/activated through step-by-step power-on.

### CROSS-REFERENCE TO RELATED APPLICATIONS

This application claims priority to Chinese Patent Application No. 202411472395.5, filed on Oct. 21, 2024 in the National Intellectual Property Administration of China, the contents of which are herein incorporated by reference in their entireties.

### TECHNICAL FIELD

Embodiments of the present disclosure relate to the field of security technologies, and in particular to a door lock control method, a door lock, and a computer device.

### BACKGROUND

With the development of technology, door locks have become increasingly intelligent. Door locks can be equipped with various sensors to achieve different artificial intelligence (AI) detections, such as face recognition, fingerprint recognition, palm vein recognition, etc.

The AI detections consume large power. In particular, a palm vein recognition assembly, which implements the palm vein recognition, can significantly impact the battery endurance of the door lock. In the related art, the power supply management for various sensors in the door locks lacks precise control, resulting in high power consumption and poor endurance in practical applications.

### SUMMARY

Some embodiments of the present disclosure provide a door lock control method, a door lock, and a computer device.

In a first aspect, the present disclosure provides a door lock control method. The method includes: acquiring an environmental perception result and performing power supply control to a distance sensor according to the environmental perception result; in a case where the distance sensor is powered on, acquiring a distance between a palm and a door lock collected by the distance sensor; and performing power supply control to a palm vein recognition module according to the distance between the palm and the door lock; the palm vein recognition module is configured to acquire a target image and perform palm vein recognition detection on the target image to control a status of the door lock.

In some embodiments, the acquiring the environmental perception result includes: determining whether a target object is present in the environment according to environmental perception data obtained from one-dimensional detection; and in a case where the target object is present in the environment, acquiring a distance between the target object and the door lock through two-dimensional detection as the environmental perception result.

In some embodiments, the performing power supply control to the distance sensor according to the environmental perception result includes: in a case where the distance between the target object and the door lock exceeds a first distance, maintaining the distance sensor in a powered-off status; and in a case where the distance between the target object and the door lock is less than or equal to the first distance, powering on the distance sensor.

In some embodiments, the performing power supply control to the palm vein recognition module according to the distance between the palm and the door lock includes: in a case where the distance between the palm and the door lock exceeds a second distance, maintaining the palm vein recognition module in a powered-off status; and in a case where the distance between the palm and the door lock is less than or equal to the second distance, powering on the palm vein recognition module.

In some embodiments, the above-mentioned method further includes: after powering on the palm vein recognition module, acquiring a detection result of the palm vein recognition detection performed by the palm vein recognition module on the target image; and adjusting a power supply status of the palm vein recognition module according to the detection result.

In some embodiments, the adjusting the power supply status of the palm vein recognition module according to the detection result includes: in a case where the detection result is that no palm is detected, acquiring the distance between the target object and the door lock; in a case where the distance between the target object and the door lock exceeds the first distance, controlling the palm vein recognition module in a powered-off status; and in a case where the distance between the target object and the door lock is less than or equal to the first distance, maintaining power supply to the palm vein recognition module.

In some embodiments, the adjusting the power supply status of the palm vein recognition module according to the detection result includes: in a case where the detection result indicates a successful palm match, controlling the palm vein recognition module in a powered-off status and controlling the door lock to be unlocked; and in a case where the detection result indicates an unsuccessful palm match, adjusting the power supply status of the palm vein recognition module according to a data acquisition status of the distance sensor.

In some embodiments, the adjusting the power supply status of the palm vein recognition module according to the data acquisition status of the distance sensor includes: in a case where the distance sensor acquires the distance between the palm and the door lock, maintaining power supply to the palm vein recognition module; and in a case where the distance sensor fails to acquire the distance between the palm and the door lock, controlling the palm vein recognition module in a powered-off status.

In some embodiments, the environmental perception result is determined by a controller based on environmental perception data collected by an environmental perception sensor through environmental detection.

In a second aspect, the present disclosure further provides a door lock, including a controller, an environmental perception sensor, a distance sensor, and a palm vein recognition module. The controller is communicatively connected to the environmental perception sensor, the distance sensor, and the palm vein recognition module. The environmental perception sensor is configured to perform environmental perception. The distance sensor is configured to acquire a distance between a palm and the door lock. The palm vein recognition module is configured to acquire a target image and to perform palm vein recognition on the target image, thereby controlling a status of the door lock. The controller is configured to determine an environmental perception result according to the environmental perception sensor, and to perform power supply control to the distance sensor according to the environmental perception result. In a case where the distance sensor is powered on, the controller is configured to acquire the distance between the palm and the door lock collected by the distance sensor. The controller is configured to perform power supply control to the palm vein recognition module according to the distance between the palm and the door lock.

In some embodiments, the environmental perception sensor includes a millimeter-wave radar and a passive infrared sensor, and/or, the distance sensor includes a time of flight sensor.

In a third aspect, the present disclosure further provides a computer device, including a memory and a processor. The memory stores a computer program. The processor implements operations of a door lock control method when executing the computer program. The method includes: acquiring an environmental perception result and performing power supply control to a distance sensor according to the environmental perception result; in a case where the distance sensor is powered on, acquiring a distance between a palm and a door lock collected by the distance sensor; and performing power supply control to a palm vein recognition module according to the distance between the palm and the door lock; the palm vein recognition module is configured to acquire a target image and perform palm vein recognition detection on the target image to control a status of the door lock.

In some embodiments, the acquiring the environmental perception result includes: determining whether a target object is present in the environment according to environmental perception data obtained from one-dimensional detection; and in a case where the target object is present in the environment, acquiring a distance between the target object and the door lock through two-dimensional detection as the environmental perception result.

In some embodiments, the performing power supply control to the distance sensor according to the environmental perception result includes: in a case where the distance between the target object and the door lock exceeds a first distance, maintaining the distance sensor in a powered-off status; and in a case where the distance between the target object and the door lock is less than or equal to the first distance, powering on the distance sensor.

In some embodiments, the performing power supply control to the palm vein recognition module according to the distance between the palm and the door lock includes: in a case where the distance between the palm and the door lock exceeds a second distance, maintaining the palm vein recognition module in a powered-off status; and in a case where the distance between the palm and the door lock is less than or equal to the second distance, powering on the palm vein recognition module.

In some embodiments, the above-mentioned method further includes: after powering on the palm vein recognition module, acquiring a detection result of the palm vein recognition detection performed by the palm vein recognition module on the target image; and adjusting a power supply status of the palm vein recognition module according to the detection result.

In some embodiments, the adjusting the power supply status of the palm vein recognition module according to the detection result includes: in a case where the detection result is that no palm is detected, acquiring the distance between the target object and the door lock; in a case where the distance between the target object and the door lock exceeds the first distance, controlling the palm vein recognition module in a powered-off status; and in a case where the distance between the target object and the door lock is less than or equal to the first distance, maintaining power supply to the palm vein recognition module.

In some embodiments, the adjusting the power supply status of the palm vein recognition module according to the detection result includes: in a case where the detection result indicates a successful palm match, controlling the palm vein recognition module in a powered-off status and controlling the door lock to be unlocked; and in a case where the detection result indicates an unsuccessful palm match, adjusting the power supply status of the palm vein recognition module according to a data acquisition status of the distance sensor.

In some embodiments, the adjusting the power supply status of the palm vein recognition module according to the data acquisition status of the distance sensor includes: in a case where the distance sensor acquires the distance between the palm and the door lock, maintaining power supply to the palm vein recognition module; and in a case where the distance sensor fails to acquire the distance between the palm and the door lock, controlling the palm vein recognition module in a powered-off status.

In some embodiments, the environmental perception result is determined by a controller based on environmental perception data collected by an environmental perception sensor through environmental detection.

### BRIEF DESCRIPTION OF THE DRAWINGS

In order to more clearly illustrate the technical solutions in the embodiments of the present disclosure or related art, the accompanying drawings to be used in the description of the embodiments or related art will be briefly described below. Obviously, drawings described below are only some embodiments of the present disclosure. Those skilled in the art can also obtain other drawings based on these drawings without creative efforts.

FIG. 1 is a structural block diagram of a door lock according to one embodiment of the present disclosure.

FIG. 2 is a schematic flowchart of a door lock control method according to one embodiment of the present disclosure.

FIG. 3 is a schematic flowchart illustrating an acquisition of an environmental perception result according to one embodiment of the present disclosure.

FIG. 4 is a schematic flowchart illustrating power supply control of a distance sensor according to one embodiment of the present disclosure.

FIG. 5 is a schematic flowchart illustrating power supply control of a palm vein recognition module according to one embodiment of the present disclosure.

FIG. 6 is a schematic flowchart illustrating an adjustment of a power supply status of the palm vein recognition module according to one embodiment of the present disclosure.

FIG. 7 is a schematic flowchart illustrating the adjustment of the power supply status of the palm vein recognition module according to another embodiment of the present disclosure.

FIG. 8 is a schematic flowchart illustrating the adjustment of the power supply status of the palm vein recognition module according to another embodiment of the present disclosure.

FIG. 9 is a schematic flowchart illustrating the adjustment of the power supply status of the palm vein recognition module according to another embodiment of the present disclosure.

FIG. 10 is a schematic flowchart of the door lock control method according to another embodiment of the present disclosure.

FIG. 11 is a structural block diagram of a door lock control apparatus according to one embodiment of the present disclosure.

FIG. 12 is a structural block diagram of a computer device according to some embodiments of the present disclosure.

### DETAILED DESCRIPTION

To make the objectives, technical solutions, and advantages of the present disclosure clearer, the present disclosure will be described clearly in detail in conjunction with the drawings and embodiments. It should be appreciated that the embodiments described herein are presented solely to illustrate the present disclosure, and are not intended to limit the present disclosure.

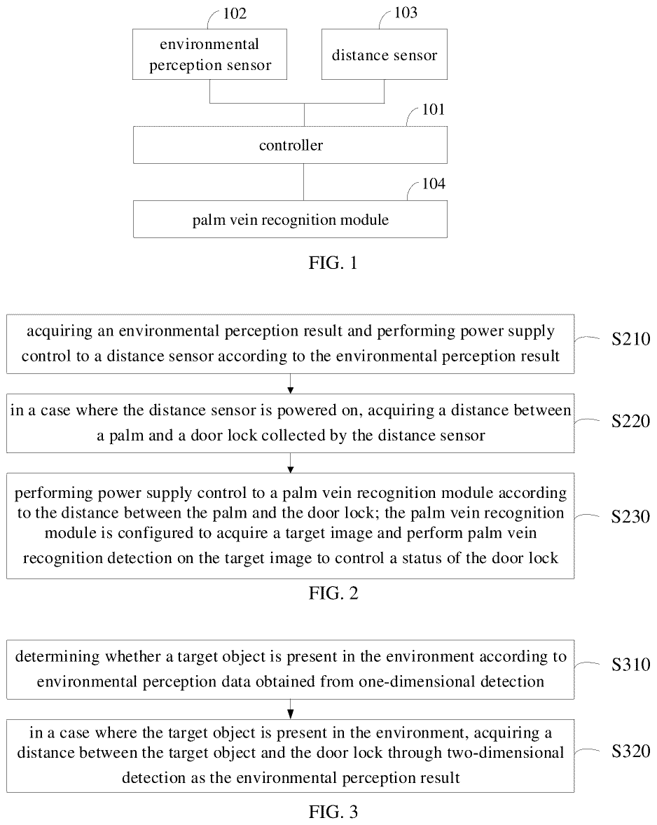

The door lock control method provided by some embodiments of the present disclosure may be implemented in the door lock as shown in FIG. 1. The door lock may include a controller 101, an environmental perception sensor 102, a distance sensor 103, and a palm vein recognition module 104. The controller 101 may be communicatively connected to the environmental perception sensor 102, the distance sensor 103, and the palm vein recognition module 104.

The environmental perception sensor 102 is configured to perform environmental perception. The distance sensor 103 is configured to acquire a distance between a palm and the door lock. The palm vein recognition module 104 is configured to acquire a target image and to perform palm vein recognition on the target image, thereby controlling a status of the door lock.

The controller 101 is configured to determine an environmental perception result according to the environmental perception sensor 102, and to perform power supply control to the distance sensor 103 according to the environmental perception result. In a case where the distance sensor 103 is powered on, the controller 101 is configured to acquire the distance between the palm and the door lock collected by the distance sensor 103, and perform power supply control to the palm vein recognition module 104 according to the distance between the palm and the door lock.

The following provides a detailed description of the various components of the door lock.

The controller 101 is a data processing center of the door lock, and is configured to collect sensor data collected by various sensors and perform corresponding control operations based on different data conditions. For example, the controller 101 may determine the environmental perception result according to the sensor data obtained from the environmental perception sensor 102 through environmental detection, and accordingly perform power supply control to the distance sensor 103 based on this environmental perception result. Furthermore, in a case where the distance sensor 103 is powered on, the controller 101 may perform power supply control to the palm vein recognition module 104 depending on the distance between the palm and the door lock collected by the distance sensor 103.

The environmental perception sensor 102 is a low-power component within the door lock, and may remain in a constantly powered-on status. The environmental perception sensor 102 is configured to collect environmental perception data within the monitoring range to perform environmental perception and obtain the environmental perception result. The environmental perception result includes an indication of whether a target object is present in the environment. The target object may be a person or an animal, or may also be other objects such as vehicles.

For example, the environmental perception sensor 102 may be a passive infrared (PIR) sensor operative to capture infrared signals and determine the presence of the target object in a case where the infrared signals are detected or a change in the infrared signals occurs. Alternatively, the environmental perception sensor 102 may be a radar, such as a millimeter-wave radar, which may transmit millimeter-wave signals into the environment by a low-power one-dimensional detection mode, and confirm the presence of the target object in a case where the reflected millimeter-wave signals are received. The environmental perception sensor 102 may also include both the PIR sensor and the radar.

The distance sensor 103 is configured for short-range detection with high accuracy. For example, the distance sensor 103 may be a time of flight (TOF) sensor.

The palm vein recognition module 104 may extract palm vein features of the palm from the target image and match them with pre-stored palm vein features to perform palm vein recognition detection. In some embodiments, the palm vein recognition module 104 may unlock the door in a case where a match is successful, or it may return a matching result to the controller 101, and the controller 101 may unlock the door in a case where the matching result is successful.

The distance sensor 103 and the palm vein recognition module 104 are disposed at the same location. In a case where a user places the palm at a designated spot, the distance sensor 103 may acquire the distance between the palm and the door lock, while the palm vein recognition module 104 may capture the target image including the palm for performing palm vein recognition detection.

Those skilled in the art may appreciate that the structure illustrated in FIG. 1 is merely a block diagram of partial structures relevant to the solutions of the present disclosure, and does not limit the computer equipment to which the solutions of the present disclosure are applied. The computer equipment in some embodiments may include more or fewer components than those illustrated in the figure, may combine certain components, or may adopt different component arrangements.

In some embodiments, the above-mentioned environmental perception sensor 102 include the PIR sensor and the millimeter-wave radar.

In practical applications, the target object may approach the door lock from any direction, such as laterally, obliquely, or longitudinally. The PIR sensor exhibits superior lateral triggering performance and may promptly detect the target object in a case where the target object laterally approaches the door lock. The millimeter-wave radar exhibits excellent oblique and longitudinal triggering performance and may promptly detect the target object in a case where the target object obliquely or longitudinally approaches the door lock.

In some embodiments, the environmental perception result is configured to indicate whether the target object is present in the environment. In a case where at lease one of the above-mentioned PIR sensor and millimeter-wave radar detects the target object presenting in the environment, the controller 101 may power on the distance sensor 103, thereby reducing omissions and enhancing detection comprehensiveness.

The present disclosure also provides a door lock control method. Taking the application of the method to the controller shown in FIG. 1 as embodiments for illustration, the method is shown in FIG. 2 and includes the following operations.

The operation S210: acquiring an environmental perception result and performing power supply control to a distance sensor according to the environmental perception result.

In some embodiments, the environmental perception result is configured to indicate whether the target object is present in the environment.

In some embodiments, the controller may perform environmental perception via the environmental perception sensor, acquire the environmental perception data collected by the environmental perception sensor, determine the environmental perception result based on the environmental perception data, and perform power supply control to the distance sensor according to the environmental perception result. For example, the environmental perception sensor may be the PIR sensor or the millimeter-wave radar.

Taking the environmental perception sensor to be the PIR sensor as embodiments, the controller may acquire infrared signals collected by the PIR sensor, and generate the environmental perception result indicating the presence of the target object in the environment in case where the infrared signals change. The controller may control the battery of the door lock to power on the distance sensor based on the environmental perception result, thereby activating the distance sensor. Conversely, in the case where the PIR sensor does not collect the infrared signals or the infrared signals do not change, the controller correspondingly generates the environmental perception result indicating the absence of the target object in the environment. The controller may not power on the distance sensor based on the environmental perception result, that is maintaining the distance sensor in a powered-off status.

The operation S220: in a case where the distance sensor is powered on, acquiring a distance between a palm and a door lock collected by the distance sensor.

In some embodiments, the distance between the palm and the door lock is the distance between the palm and the distance sensor. In a case where the distance sensor is powered on, the distance sensor may perform distance acquisition. Owing to the setting position of the distance sensor, the collected distance typically corresponds to the distance between the palm and the distance sensor.

In some embodiments, in a case where the controller powers on the distance sensor, the controller may acquire the distance collected by the distance sensor as the distance between the palm and the door lock.

The operation S230: performing power supply control to a palm vein recognition module according to the distance between the palm and the door lock; the palm vein recognition module is configured to acquire a target image and perform palm vein recognition detection on the target image to control a status of the door lock.

In some embodiments, after obtaining the distance between the palm and the door lock collected by the distance sensor, the controller may perform power supply control to determine whether the battery of the door lock supplies power to the palm vein recognition module based on the distance. For example, the controller may compare the distance between the palm and the door lock with a preset distance range. In a case where the distance between the palm and the door lock falls within the preset distance range, the controller may power on the palm vein recognition module to wake/activate the palm vein recognition module to acquire the target image and conduct palm vein recognition detection. Conversely, in a case where the distance between the palm and the door lock does not fall within the preset distance range, the controller may maintain the palm vein recognition module in a powered-off status.

For example, the preset distance may be a default value in the door lock device factory-installed, or may be a parameter subsequently configured by the user based on the actual demand.

In some embodiments, the door lock status includes unlocked and locked.

Once powered on, the palm vein recognition module may perform image acquisition, designate the collected image as the target image, recognize the palm in the target image, extract the palm vein features of the palm, and match the palm vein features against the pre-stored palm vein features, thereby accomplishing palm vein recognition detection and generating the detection result. For example, the palm vein recognition module may unlock the door in a case where the detection result indicates a successful match, and may maintain the door in the locked status in a case where the detection result indicates an unsuccessful match. The palm vein recognition module may also transmit the detection result to the controller, and the controller may control the door lock status based on the detection result.

In some embodiments of the present disclosure, the environmental perception result may be acquired and used to perform power supply control to the distance sensor. In a case where the distance sensor is powered on, the distance between the palm and the door lock collected by the distance sensor is acquired to perform power supply control to the palm vein recognition module according to the distance between the palm and the door lock. The palm vein recognition module is configured to acquire the target image and perform palm vein recognition detection to control the door lock status. In the above-mentioned method, based on the door lock including multiple sensors, various sensors may be awakened/activated through step-by-step power-on to adapt to application scenarios at different stages. This enables power supply management for various sensors in the door lock, reduces the power-on standby duration of high-power-consumption sensors, and decreases overall power consumption, thereby improving the battery endurance of the door lock.

As shown in FIG. 3, in some embodiments, to enhance the comprehensiveness of environmental perception, acquiring the environmental perception result of above-mentioned operation S210 includes the following operations.

The operation S310: determining whether a target object is present in the environment according to environmental perception data obtained from one-dimensional detection.

In some embodiments, one-dimensional detection is an operational mode supported by the environmental perception sensor, and is configured to determine whether the target object is present in the environment.

In some embodiments, the controller may control the environmental perception sensor to perform one-dimensional detection, to determine whether the target object is present in the environment according to the environmental perception data obtained from the one-dimensional detection.

For example, the environmental perception sensor may include the radar. The radar may support the one-dimensional detection mode to perform one-dimensional detection in the environment, and the radar is in low power consumption in the one-dimensional detection mode. Taking the millimeter-wave radar as an example, the millimeter-wave radar may transmit millimeter-wave signals to the environment in the one-dimensional detection mode, and receive the reflected millimeter-wave signals as the environmental perception data of the millimeter-wave radar. The environmental perception sensor may also include the passive infrared sensor. The passive infrared sensor may be configured to be awakened in a case where the infrared signals in the environment change, which also constitutes a form of one-dimensional detection to the environment, thereby receiving the infrared signals in the environment as the environmental perception data of the passive infrared sensor.

In some embodiments, in a case where the environmental perception sensor includes the radar and the passive infrared sensor, the radar in the door lock may perform environmental perception in the one-dimensional detection mode. The passive infrared sensor may also simultaneously perform environmental perception. The controller may acquire the environmental perception data collected by the radar and the passive infrared sensor. In a case where an echo signal is detected in the environmental perception data of the radar or infrared signals is present in the environmental perception data of the passive infrared sensor/infrared signals change, the controller may determine the presence of the target object in the environment.

The operation S320: in a case where the target object is present in the environment, acquiring a distance between the target object and the door lock through two-dimensional detection as the environmental perception result.

In some embodiments, the two-dimensional detection is another operational mode supported by the environmental perception sensor, and is configured to perform distance measurement.

In some embodiments, in a case where the presence of the target object in the environment is determined by the one-dimensional detection, the controller may control the environmental perception sensor to perform two-dimensional detection, thereby acquiring the distance between the target object and the environmental perception sensor in the environment. A location of the environmental perception sensor is the location of the door lock. Therefore, the obtained distance between the target object and the environmental perception sensor is the distance between the target object and the door lock, as the environmental perception result of the environmental perception sensor.

For example, the environmental perception sensor may include the radar. The radar may support the two-dimensional detection mode to perform two-dimensional detection in the environment, and the radar is in high power consumption in the two-dimensional detection mode. Taking the millimeter-wave radar as an example, the millimeter-wave radar may transmit millimeter-wave signals to the environment in the two-dimensional detection mode, and receive the reflected the reflected millimeter-wave, to determine a signal propagation distance based on the transmission time, reception time, and a propagation speed of the millimeter-wave signals, as the distance between the target object and the door lock.

In some embodiments, in a case where the target object is present in the environment, the controller may control the millimeter-wave radar to transition from the one-dimensional detection mode to the two-dimensional detection mode, and acquire the distance between the target object and the door lock collected by the millimeter-wave radar in the two-dimensional detection mode as the environmental perception result.

For example, in a case where the passive infrared sensor and/or the millimeter-wave radar in the one-dimensional detection mode determine the presence of the target object in the environment, the controller may control the millimeter-wave radar to transition from the lower-power one-dimensional detection mode to the higher-power two-dimensional detection mode, thereby acquiring the distance between the target object and the door lock collected by the millimeter-wave radar in the two-dimensional detection mode.

In some embodiments of the present disclosure, the presence of the target object in the environment may be determined by the environmental perception data obtained from the one-dimensional detection. In a case where the target object is present, the distance between the target object and the door lock may be acquired from the two-dimensional detection as the environmental perception result. In the above-mentioned method, matching trigger directions of the millimeter-wave radar and the passive infrared sensor are different. Simultaneously using the millimeter-wave radar and the passive infrared sensor to perform environmental perception may enhance the comprehensiveness of environmental perception. Furthermore, the mode of the millimeter-wave radar may be transitioned through a combination of the millimeter-wave radar and the passive infrared sensor, enabling refined control of the operational mode, and thereby further reducing the overall power consumption while extending the battery endurance of the door lock.

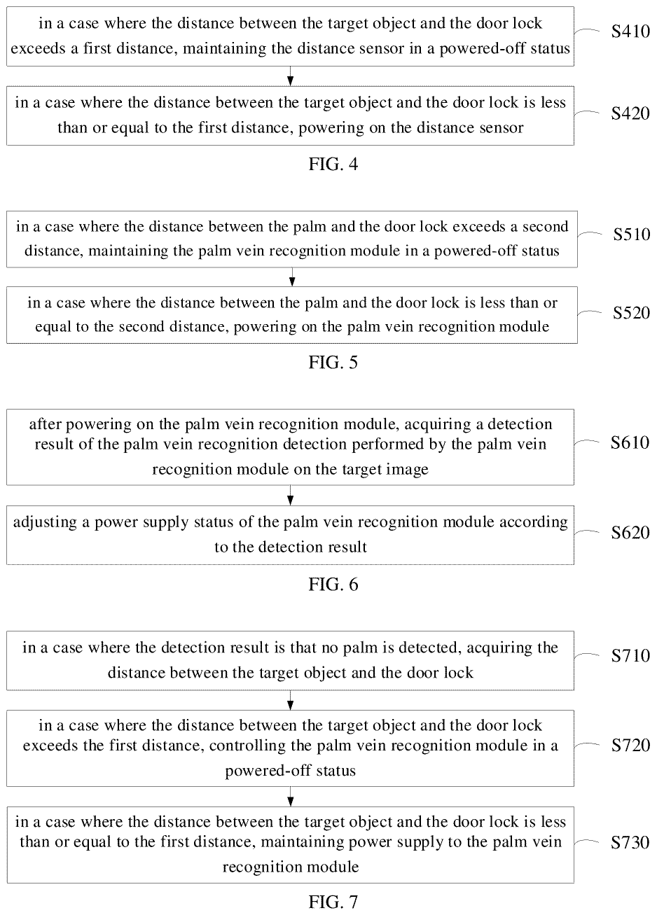

In a case where the environmental perception result includes the distance between the target object and the door lock, in some embodiments, as shown in FIG. 4, performing power supply control to the distance sensor according to the environmental perception result in the above-mentioned operation S210 includes the following operations.

The operation S410: in a case where the distance between the target object and the door lock exceeds a first distance, maintaining the distance sensor in a powered-off status.

In some embodiments, the controller may read a pre-stored first distance after obtaining the environmental perception result, and compare the target object of the environmental perception result with the first distance, thereby determining whether to power on the distance sensor according to a comparison result.

In some embodiments, acquisition of the distance between the target object and the door lock through perception indicates that the target object has entered the perceptible range of the door lock. Nevertheless, the distance between the target object and the door lock exceeding the first distance indicates that the target object relatively far from the door lock, and consequently the distance sensor needs not to be powered on at this stage.

In some embodiments, in a case where the distance between the target object and the door lock exceeds the first distance, the controller may determine that the target object is approaching the door lock. However, the target object is far from the door lock. Therefore, the battery is not commanded to power on the distance sensor, implying that the distance sensor remains in a powered-off status.

The operation S420: in a case where the distance between the target object and the door lock is less than or equal to the first distance, powering on the distance sensor.

In some embodiments, the distance between the target object and the door lock is less than or equal to the first distance, indicating that the target object is relatively close to the door lock. At this stage, the distance sensor is necessary to be powered on.

In some embodiments, in a case where the distance between the target object and the door lock is less than or equal to the first distance, the controller may determine that the target object is approaching the door lock and close to the door lock. In response, the controller may control the battery to power on the distance sensor, thereby waking/activating the distance sensor for operation.

In some embodiments of the present disclosure, in a case where the distance between the target object and the door lock exceeds the first distance, the distance sensor may be maintained in a powered-on status. In a case where the distance between the target object and the door lock is less than or equal to the first distance, the distance sensor is to be powered on. In the above-mentioned method, determining whether to power on the distance sensor based on the distance between the target object and the door lock may approach to adapt to different stages of the target object approaching to the door lock, enabling phased power activation for the distance sensor. As a result, power consumption of the distance sensor is reduced, correspondently decreasing the overall power consumption of the door lock.

Similarly, the controller may determine whether to power on the palm vein recognition module based on the relationship between the distance from the palm to the door lock and a second distance. In some embodiments, as shown in FIG. 5, performing power supply control to the palm vein recognition module according to the distance between the palm and the door lock in the above-mentioned operation S230 includes the following operations.

The operation S510: in a case where the distance between the palm and the door lock exceeds a second distance, maintaining the palm vein recognition module in a powered-off status.

In some embodiments, the distance sensor in a powered-on status may acquire the distance between the palm and the door lock. The controller may read a pre-stored second distance, and compare the distance between the palm and the door lock collected by the distance sensor with the second distance to determine whether to power on the palm vein recognition module according the comparison.

In some embodiments, the distance between the palm and the door lock collected by the distance sensor indicates that the target object has placed the palm in a designated position. Nevertheless, the distance between the palm and the door lock exceeding the second distance indicates that the palm has not reached a suitable position for palm vein recognition detection. At this stage, the palm vein recognition module needs not to be powered on.

In some embodiments, in a case where the distance between the palm and the door lock collected by the distance sensor exceeds the second distance, the controller may determine that the palm has not reached a suitable position for palm vein recognition detection. Therefore, the controller needs not to control the battery to power on the palm vein recognition module, implying that the palm vein recognition module remains in a powered-off status.

The operation S520: in a case where the distance between the palm and the door lock is less than or equal to the second distance, powering on the palm vein recognition module.

In some embodiments, the distance between the palm and the door lock is less than or equal to the second distance, indicating that the palm has reached a suitable position for palm vein recognition detection. At this stage, the palm vein recognition module is necessary to be powered on.

In some embodiments, in a case where the distance between the palm and the door lock collected by the distance sensor is less than or equal to the second distance, the controller may determine that the palm has reached a suitable position for palm vein recognition detection, thereby controlling the battery to power on the palm vein recognition module to wake/activate the palm vein recognition module to operation.

In some embodiments of the present disclosure, in a case where the distance between the palm and the door lock exceeds the second distance, the palm vein recognition module may be maintained in a powered-off status. In a case where the distance between the palm and the door lock is less than or equal to the second distance, the palm vein recognition module is to be powered on. In the above-mentioned method, determining whether to power on the palm vein recognition module based on the relationship between the distance from the palm to the door lock and the second distance, thereby confirming whether the palm reaches a suitable position for palm vein recognition detection. As a result, re-detection caused by unsuitable position is reduced, detection time is shortened, and the power consumption of the palm vein recognition module is decreased, correspondently decreasing the overall power consumption of the door lock.

In practical applications, the power supply status of the palm vein recognition module may be further adjusted based on the detection result of the palm vein recognition detection. Accordingly, in some embodiments, as shown in FIG. 6, the above-mentioned method further includes the following operations.

The operation S610: after powering on the palm vein recognition module, acquiring a detection result of the palm vein recognition detection performed by the palm vein recognition module on the target image.

In some embodiments, once the palm vein recognition module is powered on, the palm vein recognition module may acquire the target image, and perform palm vein recognition detection on the target image to obtain the detection result. The controller may correspondently acquire the detection result of the palm vein recognition detection performed by the palm vein recognition module on the target image.

The operation S620: adjusting a power supply status of the palm vein recognition module according to the detection result.

In some embodiments, once the controller obtains the detection result of the palm vein recognition module, the controller may control the battery to continue to power on the palm vein recognition module based on to the detection result, thereby maintaining the palm vein recognition module in a powered-on status. Alternatively, the controller may cut off the power supply from the battery to the palm vein recognition to power off the palm vein recognition module, thereby adjusting the power supply status of the palm vein recognition module.

For example, the detection result may include a successful detection and an unsuccessful detection. In a case where the detection result is a successful detection, once the palm vein recognition module controls the door lock to be unlocked, the controller may control the battery to cut off the power supply to the palm vein recognition module, thereby maintaining the palm vein recognition module in a powered-off status. Conversely, in a case where the detection result indicates an unsuccessful detection, the controller may control the battery to maintain power supply to the palm vein recognition module for a preset duration and maintain the palm vein recognition module in a powered-on status, thereby allowing the user to retry to unlock the door. Alternatively, the controller may directly control the battery to cut off the power supply to the palm vein recognition module.

In some embodiments of the present disclosure, after powering on the palm vein recognition module, the detection result of the palm vein recognition detection performed by the palm vein recognition module on the target image may be acquired, enabling adjustment of the power supply status of the palm vein recognition module according to the detection result. In the above-mentioned method, the power supply status of the palm vein recognition module in a powered-on status may be adjusted according to the detection result of the palm vein recognition module, enhancing the comprehensiveness of door lock control.

The detection result includes a case where no palm is detected. Accordingly, in some embodiments, as shown in FIG. 7, the adjustment of the power supply status of the palm vein recognition module according to the detection result in the above-mentioned operation S620 includes the following operations.

The operation S710: in a case where the detection result is that no palm is detected, acquiring the distance between the target object and the door lock.

In some embodiments, the detection result that no palm is detected correspondingly indicates that the detection result is an unsuccessful detection. The situation where no palm is detected corresponds to multiple scenarios, such as the target object withdrawing the palm, the palm is not fully extended (e.g., clenched fist), the palm is holding another object (e.g., keys), etc.

The palm vein recognition module in a powered-on status may acquire the target image and identify the palm within the target image to extract palm vein features in the palm for palm vein features match. In a case where the palm vein recognition module fails to recognize a palm in the target image, a detection result that no palm is detected may be generated.

In some embodiments, in a case where the controller acquires the detection result of the palm vein recognition module that no palm is detected, the controller may further acquire the distance between the target object and the door lock under the current circumstance. In some embodiments, the controller may acquire the distance collected by the millimeter-wave radar in the two-dimensional detection mode, implying the distance between the target object and the door lock.

The operation S720: in a case where the distance between the target object and the door lock exceeds the first distance, controlling the palm vein recognition module in a powered-off status.

In some embodiments, the palm vein recognition module fails to detect a palm, while the millimeter-wave radar detects the distance between the target object and the door lock exceeding the first distance, indicating that the target object has been far away from the door lock, and unlikely to attempt unlocking again in a short time. Therefore, the palm vein recognition module may be controlled in a powered-off status.

In some embodiments, the controller may compare the acquired distance between the target object and the door lock with the first distance, and control the battery to cut off the power supply to the palm vein recognition module in a case where the distance between the target object and the door lock exceeds the first distance.

The operation S730: in a case where the distance between the target object and the door lock is less than or equal to the first distance, maintaining power supply to the palm vein recognition module.

In some embodiments, the palm vein recognition module fails to detect the palm, while the millimeter-wave radar detects the distance between the target object and the door lock less than or equal to the first distance, indicating that the target object remains near the door lock and may attempt to unlock the door again. Therefore, the palm vein recognition module may maintain in a powered-on status.

In some embodiments, the controller may compare the acquired distance between the target object and the door lock with the first distance, and control the battery to power on the palm vein recognition module in a case where the distance between the target object and the door lock is less than or equal to the first distance, thereby extending the power-on duration of the palm vein recognition module and allowing the user to continue attempting to unlock the door.

For example, in a case where the distance between the target object and the door lock is less than or equal to the first distance, the controller may control the battery to maintain power supply to the palm vein recognition module. For instance, the controller may extend the power-on duration of the preset duration, allowing the palm vein recognition module to repeatedly acquire the target object for palm vein recognition detection within the preset duration until a successful detection is achieved. Alternatively, once the number of power-on duration extensions reaches upper limit, the controller may control the battery to cut off power supply to the palm vein recognition module.

In some embodiments of the present disclosure, in a case where the detection result is that no palm is detected, the distance between the target object and the door lock may be acquired. In a case where the distance between the target object and the door lock exceeds the first distance, the palm vein recognition module may be controlled in a powered-off status. In a case where the distance between the target object and the door lock is less than or equal to the first distance, the palm vein recognition module may maintain in a powered-on status. In the above-mentioned method, adjustment of a subsequent power supply status of the palm vein recognition module in scenarios where no palm is detected is implemented, and the adaptability between an adjustment process and an actual usage scene is improved, correspondingly enhancing the rationality of power supply status adjustment for the palm vein recognition module and reducing the power consumption of the palm vein recognition module.

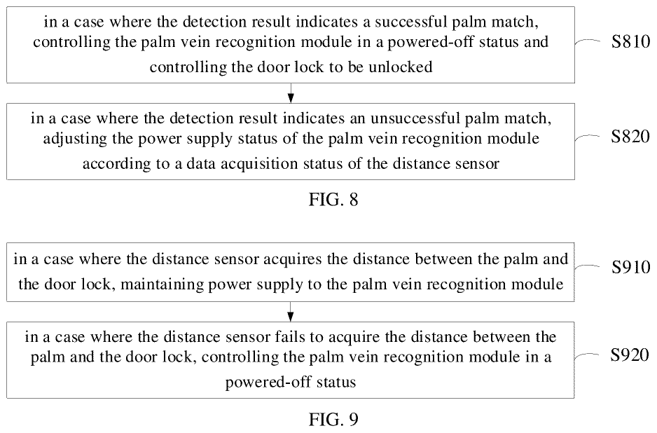

In a case where a palm is detected, in some embodiments, as shown in FIG. 8, the adjustment of the power supply status of the palm vein recognition module according to the detection result in the above-mentioned operation S620 includes the following operations.

The operation S810: in a case where the detection result indicates a successful palm match, controlling the palm vein recognition module in a powered-off status and controlling the door lock to be unlocked.

In some embodiments, the detection result is a successful palm match, correspondingly indicating a successful detection. A successful palm match corresponds to a scenario in which the palm vein features in the palm of the target image collected by the palm vein recognition module successfully match the pre-stored palm vein features. The door lock may be successfully unlocked, and the user needs not to attempt unlocking again, thereby controlling the palm vein recognition module in a powered-off status.

After powering on, the palm vein recognition module may acquire the target image and identify the palm within the target image, thereby extracting palm vein features of the palm to perform palm vein features match. In a case where the palm vein recognition module identifies the palm within the target image, if the palm vein features of the palm extracted from the target image successfully match a pre-stored palm vein, the detection result indicating a successful palm match may be generated.

In some embodiments, in a case where the controller acquires the detection result from the palm vein recognition module indicating a successful palm match, the controller may unlock the door lock and control the battery to cut off the power supply to the palm vein recognition module.

The operation S820: in a case where the detection result indicates an unsuccessful palm match, adjusting the power supply status of the palm vein recognition module according to a data acquisition status of the distance sensor.

In some embodiments, the detection result is an unsuccessful palm match, correspondingly indicating an unsuccessful detection. A successful palm match corresponds to a scenario in which the palm vein features in the palm of the target image collected by the palm vein recognition module successfully match the pre-stored palm vein features. The door lock may remain locked.

Once the palm vein recognition module is powered on, if the palm vein features of the palm extracted from the target image fail to match the pre-stored palm vein, the detection result indicating an unsuccessful palm match may be generated.

In some embodiments, in a case where the controller acquires the detection result from the palm vein recognition module indicating an unsuccessful palm match, the controller may adjust the power supply status of the palm vein recognition module based on the data acquisition status of the distance sensor under the current circumstance.

The data acquisition status of the distance sensor includes a case where the distance between the palm and the door lock is acquired and a case where the distance between the palm and the door lock fails to be acquired. Accordingly, in some embodiments, as shown in FIG. 9, the adjustment of the power supply status of the palm vein recognition module according to the data acquisition status of the distance sensor in the above-mentioned operation S820 includes the following operations.

The operation S910: in a case where the distance sensor acquires the distance between the palm and the door lock, maintaining power supply to the palm vein recognition module.

In some embodiments, the palm vein recognition module may detect an unsuccessful palm match and the distance sensor may acquire the distance between the palm and the door lock, indicating that the target object is extending the palm attempting to unlock the door. Therefore, the power supply to the palm vein recognition module may be maintained.

In some embodiments, in a case where the controller acquires the detection result from the palm vein recognition module indicating an unsuccessful palm match and the distance sensor acquires the distance between the palm and the door lock, the controller may control the battery to maintain power supply to the palm vein recognition module, thereby extending the power-on duration of the palm vein recognition module and allowing the user to continue attempting to unlock the door.

For example, the controller may control the battery to maintain power supply to the palm vein recognition module. For instance, the controller may extend the power-on duration of the preset duration, allowing the palm vein recognition module to repeatedly acquire the target object for palm vein recognition detection within the preset duration until a successful detection is achieved. Alternatively, once the number of power-on duration extensions reaches upper limit, the controller may control the battery to cut off power supply to the palm vein recognition module.

The operation S920: in a case where the distance sensor fails to acquire the distance between the palm and the door lock, controlling the palm vein recognition module in a powered-off status.

In some embodiments, the palm vein recognition module may detect an unsuccessful palm match and the distance sensor may fail to acquire the distance between the palm and the door lock, indicating that the target object has withdrawn the palm, and thereby controlling the palm vein recognition module in a powered-off status.

In some embodiments, in a case where the controller acquires the detection result from the palm vein recognition module indicating an unsuccessful palm match and the distance sensor fails to acquire the distance between the palm and the door lock, the controller may directly control the battery to cut off power supply to the palm vein recognition module.

It is to be noted that, the above-mentioned first duration, second duration and preset duration may be default values in the door lock device factory-installed, or may be parameters subsequently configured by the user based on the actual demand.

In some embodiments of the present disclosure, the palm vein recognition module may be controlled in a powered-off status and the door lock may be controlled to be unlocked in a case where the detection result indicates a successful palm match, and the power supply status of the palm vein recognition module may be adjusted according to the data acquisition status of the distance sensor in a case where the detection result indicates an unsuccessful palm match. In some embodiments, the palm vein recognition module may be maintained in a powered-on status in a case where the distance sensor acquires the distance between the palm and the door lock, and the palm vein recognition module may be controlled in a powered-off status in a case where the distance sensor fails to acquire the distance between the palm and the door lock. In the above-mentioned method, the palm vein matching status and the data acquisition status of the distance sensor may accurately reflect power supply requirements for the palm vein recognition module in actual scenarios. Accordingly, the adjustment of the power supply status of the palm vein recognition module may be performed to make the adjustment process in line with actual needs, thereby reducing the power consumption while improving a response timeliness of the palm vein recognition module.

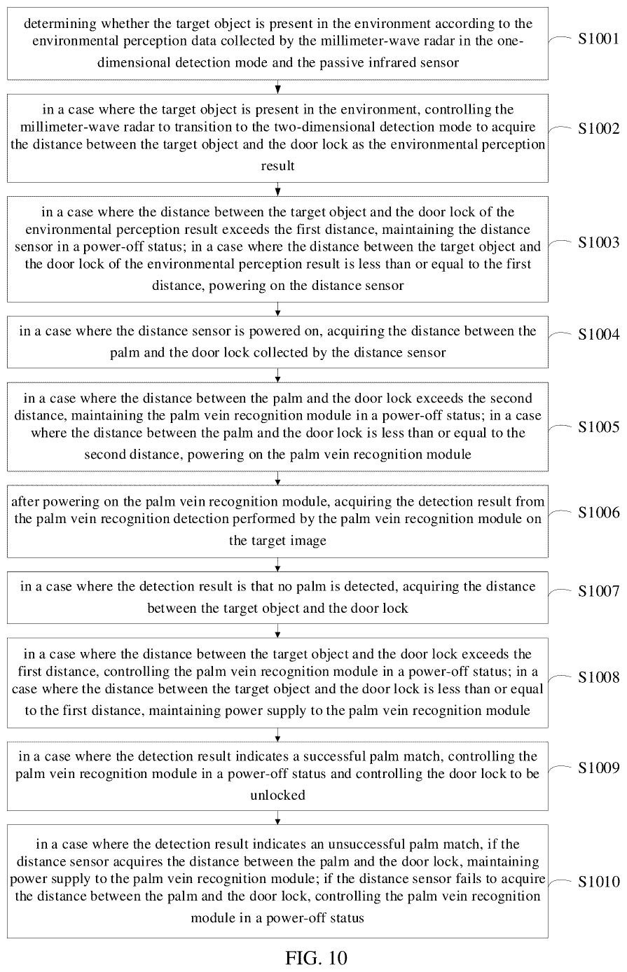

For the convenience of understanding by those skilled in the art, the following presents a detailed introduction to the door lock control method provided in the present disclosure. As shown in FIG. 10, the method may include the following operations.

The operation S1001: determining whether the target object is present in the environment according to the environmental perception data collected by the millimeter-wave radar in the one-dimensional detection mode and the passive infrared sensor.

The operation S1002: in a case where the target object is present in the environment, controlling the millimeter-wave radar to transition to the two-dimensional detection mode to acquire the distance between the target object and the door lock as the environmental perception result.

The operation S1003: in a case where the distance between the target object and the door lock of the environmental perception result exceeds the first distance, maintaining the distance sensor in a power-off status; in a case where the distance between the target object and the door lock of the environmental perception result is less than or equal to the first distance, powering on the distance sensor.

The operation S1004: in a case where the distance sensor is powered on, acquiring the distance between the palm and the door lock collected by the distance sensor.

The operation S1005: in a case where the distance between the palm and the door lock exceeds the second distance, maintaining the palm vein recognition module in a power-off status; in a case where the distance between the palm and the door lock is less than or equal to the second distance, powering on the palm vein recognition module.

The operation S1006: after powering on the palm vein recognition module, acquiring the detection result from the palm vein recognition detection performed by the palm vein recognition module on the target image.

The operation S1007: in a case where the detection result is that no palm is detected, acquiring the distance between the target object and the door lock.

The operation S1008: in a case where the distance between the target object and the door lock exceeds the first distance, controlling the palm vein recognition module in a power-off status; in a case where the distance between the target object and the door lock is less than or equal to the first distance, maintaining power supply to the palm vein recognition module.

The operation S1009: in a case where the detection result indicates a successful palm match, controlling the palm vein recognition module in a power-off status and controlling the door lock to be unlocked.

The operation S1010: in a case where the detection result indicates an unsuccessful palm match, if the distance sensor acquires the distance between the palm and the door lock, maintaining power supply to the palm vein recognition module; if the distance sensor fails to acquire the distance between the palm and the door lock, controlling the palm vein recognition module in a power-off status.

It is to be noted that, reference may be made to the corresponding descriptions provided in the above-mentioned embodiments for descriptions related to the above-mentioned operations S1001-S1010, as the effects are similar. No further elaboration is provided herein.

It should be understood that, although the operations in the flowcharts described in the above-mentioned embodiments are displayed sequentially as indicated by the arrows, these operations are not necessarily executed in the order indicated by the arrows. Unless explicitly stated herein, these operations are subject to no strict sequential limitation and may be performed in other orders. Furthermore, at least some of the operations in the flowcharts involved in the above-mentioned embodiments may include multiple sub-operations or multiple stages, which are not necessarily executed at the same time but may be performed at different times. The execution order of these sub-operations or stages is not necessarily sequential, and may be executed alternately or interchangeably with at least portions of other operations or sub-operations.

Based on the same inventive concept, embodiments of the present disclosure further provide a door lock control apparatus configured to carry out the above-mentioned door lock control method. The solution provided by the apparatus to address the technical problem is similar to the solution described in the above-mentioned method. Therefore, specific limitations in one or more door lock control apparatus embodiments provided below may refer to limitations in the door lock control method above, and no further elaboration is provided herein.

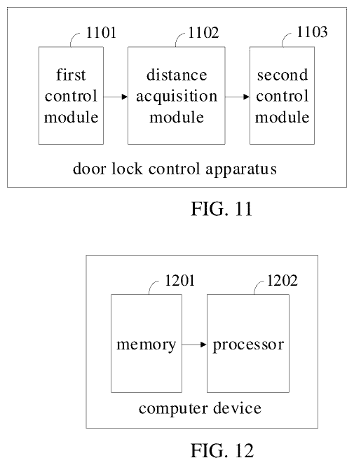

In some exemplary embodiments, as shown in FIG. 11, a door lock control apparatus is provided, including a first control module 1101, a distance acquisition module 1102, and a second control module 1103.

The first control module 1101 is configured to acquire the environmental perception result and perform power supply control to the distance sensor.

The distance acquisition module 1102 is configured to acquire the distance between the palm and the door lock collected by the distance sensor in a case where the distance sensor is powered on.

The second control module 1103 is configured to perform power supply control to the palm vein recognition module according to the distance between the palm and the door lock. The palm vein recognition module is configured to acquire the target image and perform palm vein recognition detection on the target image to control the door lock status.

The modules in the above-mentioned door lock control apparatus may be implemented entirely or partially through software, hardware, or a combination thereof. The above-mentioned modules may be embedded in or independent of a processor of a computer device in the form of hardware, or may be stored in a memory of the computer device in a form of software to facilitate the processor in invoking and executing the operations corresponding to each module.

In some embodiments of the present disclosure, as shown in FIG. 12, a computer device is provided, including a memory 1201 and a processor 1202. The memory 1201 stores a computer program, and the processor 1202 implements the operations of the above-mentioned door lock control method when executing the computer program.

Acquiring an environmental perception result and performing power supply control to a distance sensor according to the environmental perception result.

In a case where the distance sensor is powered on, acquiring a distance between a palm and a door lock collected by the distance sensor.

Performing power supply control to a palm vein recognition module according to the distance between the palm and the door lock; the palm vein recognition module is configured to acquire a target image and perform palm vein recognition detection on the target image to control a status of the door lock.

In some embodiments, the acquiring the environmental perception result may include the following operations. Determining whether a target object is present in the environment according to environmental perception data obtained from one-dimensional detection. In a case where the target object is present in the environment, acquiring a distance between the target object and the door lock through two-dimensional detection as the environmental perception result.

In some embodiments, the performing power supply control to the distance sensor according to the environmental perception result may include the following operations. In a case where the distance between the target object and the door lock exceeds a first distance, maintaining the distance sensor in a powered-off status. In a case where the distance between the target object and the door lock is less than or equal to the first distance, powering on the distance sensor.

In some embodiments, the performing power supply control to the palm vein recognition module according to the distance between the palm and the door lock may include the following operations. In a case where the distance between the palm and the door lock exceeds a second distance, maintaining the palm vein recognition module in a powered-off status. In a case where the distance between the palm and the door lock is less than or equal to the second distance, powering on the palm vein recognition module.

In some embodiments, the door lock control method may further include the following operations. After powering on the palm vein recognition module, acquiring a detection result of the palm vein recognition detection performed by the palm vein recognition module on the target image. Adjusting a power supply status of the palm vein recognition module according to the detection result.

In some embodiments, the adjusting the power supply status of the palm vein recognition module according to the detection result may include the following operations. In a case where the detection result is that no palm is detected, acquiring the distance between the target object and the door lock. In a case where the distance between the target object and the door lock exceeds the first distance, controlling the palm vein recognition module in a powered-off status. In a case where the distance between the target object and the door lock is less than or equal to the first distance, maintaining power supply to the palm vein recognition module.

In some embodiments, the adjusting the power supply status of the palm vein recognition module according to the detection result may include the following operations. In a case where the detection result indicates a successful palm match, controlling the palm vein recognition module in a powered-off status and controlling the door lock to be unlocked. In a case where the detection result indicates an unsuccessful palm match, adjusting the power supply status of the palm vein recognition module according to a data acquisition status of the distance sensor.

In some embodiments, the adjusting the power supply status of the palm vein recognition module according to the data acquisition status of the distance sensor may include the following operations. In a case where the distance sensor acquires the distance between the palm and the door lock, maintaining power supply to the palm vein recognition module. In a case where the distance sensor fails to acquire the distance between the palm and the door lock, controlling the palm vein recognition module in a powered-off status.

In some embodiments, the environmental perception result may be determined by a controller based on the environmental perception data collected by an environmental perception sensor through environmental detection.

In some embodiments, a computer readable storage medium is provided that stores the computer program. The computer program implements the operations of any of the above-mentioned methods when executed by the processor.

In some embodiments, a computer program product is provided, including the computer program. The computer program implements the operations of any of the above-mentioned methods when executed by the processor.

Those skilled in the art may appreciate that the entire or partial processes required to implement methods of the above-mentioned may be accomplished by executing the computer program instructing relevant hardware. The computer program may be stored in a non-volatile computer readable storage medium. When executed, the computer program may include processes of the embodiments in the above-mentioned methods. Any reference herein to the memory, databases, or other medium in the embodiments provided by the present disclosure may include at least one of non-volatile memory and volatile memory. The non-volatile memory may include read-only memory (ROM), magnetic tape, floppy disks, flash memory, optical storage, high-density embedded non-volatile memory, resistive random access memory (ReRAM), magnetoresistive random access memory (MRAM), ferroelectric random access memory (FRAM), phase change memory (PCM), etc. The volatile memory may include random access memory (RAM), external cache memory, etc. As an illustration rather than a limitation, RAM may take various forms, such as static random access memory (SRAM), dynamic random access memory (DRAM), etc. The databases involved in the embodiments provided by the present disclosure may include at least one of relational databases and non-relational databases. The non-relational databases may include, but are not limited to, blockchain-based distributed databases. The processors involved in the embodiments provided by the present disclosure may be, but are not limited to, general-purpose processor, central processor, graphics processor, digital signal processor, programmable logic device, quantum computing-based data processing logic device, artificial intelligence (AI) processor, etc.

The technical features of the above-mentioned embodiments may be arbitrarily combined. In order to make the description concise, not all possible combinations of the technical features in the above-mentioned embodiments have been described. However, any combination of these technical features shall be considered as falling within the scope of the present disclosure, provided the combination presents no conflict.

The above descriptions are merely some embodiments of the present disclosure. Although the descriptions are relatively specific and detailed, they should not be construed as limiting the scope of the patent claims of the present disclosure. It should be noted that, those skilled in the art may make various modifications and improvements without departing from the inventive concept of the present disclosure, and all such variations shall fall within the protection scope of the present disclosure. Therefore, the protection scope of the present disclosure shall be subject to the appended claims.

1. A door lock control method, comprising:
acquiring an environmental perception result and performing power supply control to a distance sensor according to the environmental perception result;
in a case where the distance sensor is powered on, acquiring a distance between a palm and a door lock collected by the distance sensor; and
performing power supply control to a palm vein recognition module according to the distance between the palm and the door lock; wherein the palm vein recognition module is configured to acquire a target image and perform palm vein recognition detection on the target image to control a status of the door lock.

2. The method as claimed in claim 1, wherein the acquiring the environmental perception result comprises:
determining whether a target object is present in the environment according to environmental perception data obtained from one-dimensional detection; and
in a case where the target object is present in the environment, acquiring a distance between the target object and the door lock through two-dimensional detection as the environmental perception result.

3. The method as claimed in claim 2, wherein the performing power supply control to the distance sensor according to the environmental perception result comprises:
in a case where the distance between the target object and the door lock exceeds a first distance, maintaining the distance sensor in a powered-off status; and
in a case where the distance between the target object and the door lock is less than or equal to the first distance, powering on the distance sensor.

4. The method as claimed in claim 1, wherein the performing power supply control to the palm vein recognition module according to the distance between the palm and the door lock comprises:
in a case where the distance between the palm and the door lock exceeds a second distance, maintaining the palm vein recognition module in a powered-off status; and
in a case where the distance between the palm and the door lock is less than or equal to the second distance, powering on the palm vein recognition module.

5. The method as claimed in claim 1, further comprising:
after powering on the palm vein recognition module, acquiring a detection result of the palm vein recognition detection performed by the palm vein recognition module on the target image; and
adjusting a power supply status of the palm vein recognition module according to the detection result.

6. The method as claimed in claim 5, wherein the adjusting the power supply status of the palm vein recognition module according to the detection result comprises:
in a case where the detection result is that no palm is detected, acquiring the distance between the target object and the door lock;
in a case where the distance between the target object and the door lock exceeds the first distance, controlling the palm vein recognition module in a powered-off status; and
in a case where the distance between the target object and the door lock is less than or equal to the first distance, maintaining power supply to the palm vein recognition module.

7. The method as claimed in claim 5, wherein the adjusting the power supply status of the palm vein recognition module according to the detection result comprises:
in a case where the detection result indicates a successful palm match, controlling the palm vein recognition module in a powered-off status and controlling the door lock to be unlocked; and
in a case where the detection result indicates an unsuccessful palm match, adjusting the power supply status of the palm vein recognition module according to a data acquisition status of the distance sensor.

8. The method as claimed in claim 7, wherein the adjusting the power supply status of the palm vein recognition module according to the data acquisition status of the distance sensor comprises:
in a case where the distance sensor acquires the distance between the palm and the door lock, maintaining power supply to the palm vein recognition module; and
in a case where the distance sensor fails to acquire the distance between the palm and the door lock, controlling the palm vein recognition module in a powered-off status.

9. The method as claimed in claim 1, wherein the environmental perception result is determined by a controller based on environmental perception data collected by an environmental perception sensor through environmental detection.

10. A door lock, comprising a controller, an environmental perception sensor, a distance sensor, and a palm vein recognition module;
wherein the controller is communicatively connected to the environmental perception sensor, the distance sensor, and the palm vein recognition module;
wherein the environmental perception sensor is configured to perform environmental perception; the distance sensor is configured to acquire a distance between a palm and the door lock; the palm vein recognition module is configured to acquire a target image and to perform palm vein recognition on the target image, thereby controlling a status of the door lock; and
wherein the controller is configured to determine an environmental perception result according to the environmental perception sensor, and to perform power supply control to the distance sensor according to the environmental perception result; in a case where the distance sensor is powered on, the controller is configured to acquire the distance between the palm and the door lock collected by the distance sensor; the controller is configured to perform power supply control to the palm vein recognition module according to the distance between the palm and the door lock.

11. The door lock as claimed in claim 10, wherein the environmental perception sensor comprises a millimeter-wave radar and a passive infrared sensor, and/or, the distance sensor comprises a time of flight sensor.

12. A computer device, comprising a memory and a processor; wherein the memory stores a computer program; wherein the processor implements operations of a door lock control method when executing the computer program; wherein the method comprises:
acquiring an environmental perception result and performing power supply control to a distance sensor according to the environmental perception result;
in a case where the distance sensor is powered on, acquiring a distance between a palm and a door lock collected by the distance sensor; and
performing power supply control to a palm vein recognition module according to the distance between the palm and the door lock; wherein the palm vein recognition module is configured to acquire a target image and perform palm vein recognition detection on the target image to control a status of the door lock.

13. The computer device as claimed in claim 12, wherein the acquiring the environmental perception result comprises:
determining whether a target object is present in the environment according to environmental perception data obtained from one-dimensional detection; and
in a case where the target object is present in the environment, acquiring a distance between the target object and the door lock through two-dimensional detection as the environmental perception result.

14. The computer device as claimed in claim 13, wherein the performing power supply control to the distance sensor according to the environmental perception result comprises:
in a case where the distance between the target object and the door lock exceeds a first distance, maintaining the distance sensor in a powered-off status; and
in a case where the distance between the target object and the door lock is less than or equal to the first distance, powering on the distance sensor.

15. The computer device as claimed in claim 12, wherein the performing power supply control to the palm vein recognition module according to the distance between the palm and the door lock comprises:
in a case where the distance between the palm and the door lock exceeds a second distance, maintaining the palm vein recognition module in a powered-off status; and
in a case where the distance between the palm and the door lock is less than or equal to the second distance, powering on the palm vein recognition module.

16. The computer device as claimed in claim 12, wherein the method further comprises:
after powering on the palm vein recognition module, acquiring a detection result of the palm vein recognition detection performed by the palm vein recognition module on the target image; and
adjusting a power supply status of the palm vein recognition module according to the detection result.

17. The computer device as claimed in claim 16, wherein the adjusting the power supply status of the palm vein recognition module according to the detection result comprises:
in a case where the detection result is that no palm is detected, acquiring the distance between the target object and the door lock;
in a case where the distance between the target object and the door lock exceeds the first distance, controlling the palm vein recognition module in a powered-off status; and
in a case where the distance between the target object and the door lock is less than or equal to the first distance, maintaining power supply to the palm vein recognition module.

18. The computer device as claimed in claim 16, wherein the adjusting the power supply status of the palm vein recognition module according to the detection result comprises:
in a case where the detection result indicates a successful palm match, controlling the palm vein recognition module in a powered-off status and controlling the door lock to be unlocked; and
in a case where the detection result indicates an unsuccessful palm match, adjusting the power supply status of the palm vein recognition module according to a data acquisition status of the distance sensor.

19. The computer device as claimed in claim 18, wherein the adjusting the power supply status of the palm vein recognition module according to the data acquisition status of the distance sensor comprises:
in a case where the distance sensor acquires the distance between the palm and the door lock, maintaining power supply to the palm vein recognition module; and
in a case where the distance sensor fails to acquire the distance between the palm and the door lock, controlling the palm vein recognition module in a powered-off status.

20. The computer device as claimed in claim 12, wherein the environmental perception result is determined by a controller based on environmental perception data collected by an environmental perception sensor through environmental detection.
